(19) United States
(12) Patent Application Publication
(10) Pub. No.: US 2006/0246875 A1
(43) Pub. Date: Nov. 2, 2006

(54) Mobile Telephone with Connection Indicator

(76) Inventor: Won-Moo Song, Haltom City, TX (US)

Correspondence Address: CARSTENS & CAHOON, LLP, P O BOX 802334, DALLAS, TX, 75380, US

(21) Appl. No.: 10/908,206

(22) Filed: May 2, 2005

(51) Int. Cl. H04Q 7/22; H04M 1/663; H04M 1/725

(52) U.S. Cl. 455/412.2

(57) ABSTRACT

A mobile telephone with a connection indicator to allow a user to place a call without exposing his or her brain to significant amounts of radiation unless and until the call is successfully connected is disclosed. In a preferred embodiment, light emitting diodes (LEDs) are used to signal the user when connection is being attempted and when a successful connection has been made. In this way, the user need not listen to the earpiece (thus exposing himself or herself to the antenna's radiation) in order to determine whether the call was successful. In the preferred embodiment, additional protection from radiation exposure is provided by placing the antenna near the microphone and away from the earpiece. In alternative embodiments of the invention, signaling means other than the visual cue of the LEDs may be used to notify the user that the call has successfully connected.

### TECHNICAL FIELD

The present invention relates generally to the area of mobile telephones. Specifically, the present invention provides a novel mobile telephone design including a visual indicator for signifying whether a call has succeeded in connecting or not and a retractable antenna placed near the microphone and away from the earpiece so as to minimize the user's radiation exposure.

### DESCRIPTION OF THE RELATED ART

Many scientists, engineers, and physicians have expressed concern about the health risks associated with prolonged mobile telephone use. A typical mobile telephone must send ultra-high frequency or microwave radiation, over fairly long-range distances, and, therefore, with a relatively high level of power. Because today's smaller mobile telephones have antennas that are placed in close proximity to the user's skull when operating the phone, the user's brain experiences significant amount of electromagnetic radiation at close range.

Thus, it is desirable to allow a user to operate a mobile telephone with a minimum amount of radiation exposure. One particularly unsatisfactory situation in which a user can be exposed to such radiation is when initially placing a call. If the user makes repeated unsuccessful attempts to contact a party, the user will be exposed to the radiation repeatedly, and without enjoying the benefit of a successful connection.

What is needed, therefore, is a method of allowing a user to place calls on a mobile telephone in which the user's brain is only exposed to significant amounts of radiation in the event that the call is successfully connected. The present invention provides a solution to this and other problems, and offers other advantages over previous solutions.

### SUMMARY

The present invention provides a mobile telephone with a connection indicator to allow a user to place a call without exposing his or her brain to significant amounts of radiation unless and until the call is successfully connected. In a preferred embodiment, light emitting diodes (LEDs) are used to signal the user when connection is being attempted and when a successful connection has been made. In this way, the user need not listen to the earpiece (thus exposing himself or herself to the antenna's radiation) in order to determine whether the call was successful. In the preferred embodiment, additional protection from radiation exposure is provided by placing the antenna near the microphone and away from the earpiece. In alternative embodiments of the invention, signaling means other than the visual cue of the LEDs may be used to notify the user that the call has successfully connected. For instance, sound, or vibration may be used to signal the user as to a successful call.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of the exterior of a mobile telephone made in accordance with a preferred embodiment of the present invention;

FIG. 2 is a block diagram of a mobile telephone made in accordance with a preferred embodiment of the present invention; and

FIG. 3 is a flowchart representation of a process of visually notifying a user of a mobile telephone that a connection has or has not succeeded, in accordance with a preferred embodiment of the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

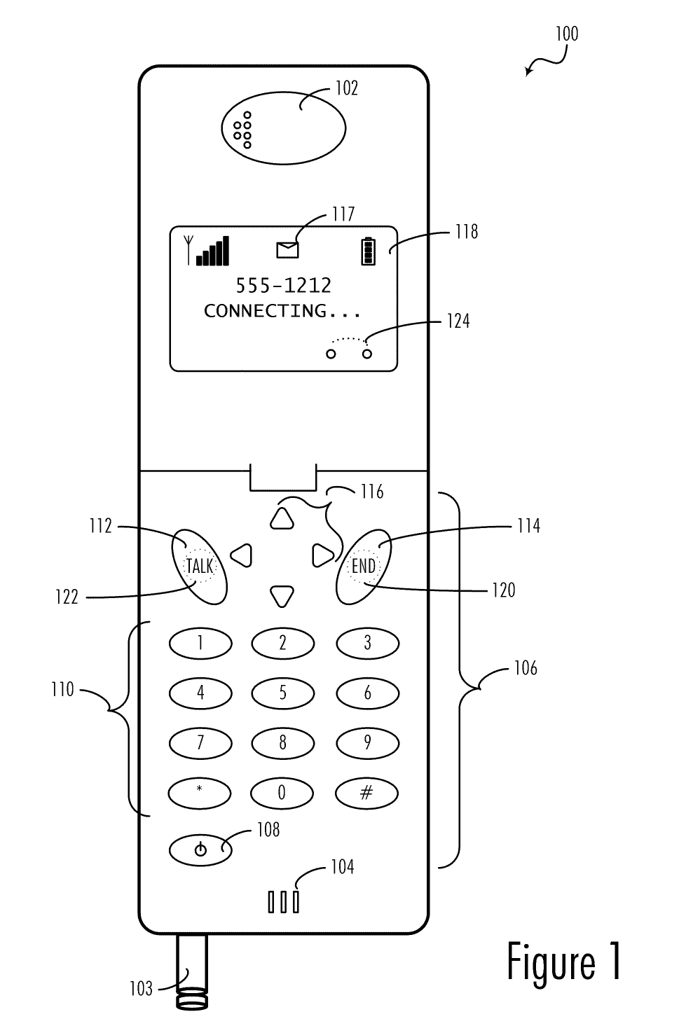

FIG. 1 depicts a mobile telephone 100 constructed in accordance with a preferred embodiment of the present invention. Like a conventional telephone, mobile telephone 100 contains an earpiece 102, a microphone 104, and a keypad 106 for emitting DTMF (Dual-Tone Multiple Frequency) tones for dialing. Mobile telephone 100, unlike a conventional telephone, uses an antenna 103 as its communications link to the Public Switched Telephone Network (PSTN), the standard public telephone network through which most telephone calls are routed. Antenna 103 is, in this preferred embodiment, mounted near microphone 104 and at a distance from earpiece 102 so as to minimize exposure of the user's brain to radiation from antenna 103. In one possible embodiment of the invention, antenna 103 may be fully retracted into the body of mobile telephone 100 so that antenna 103 does not protrude from mobile telephone 100 when mobile telephone 100 mobile telephone 100 is not in use.

Mobile telephone 100 may transmit and receive data, including but not limited to voice data, through an analog-coded or digitally coded signal. One common communications standard for mobile telephones is GSM (Global System for Mobile communications), which is an international standard for digital wireless telephony. Some mobile telephones, such as dual-band mobile telephones, will allow multiple frequency bands or even multiple communications standards to be used with the same telephone; this is a convenience, particularly in remote areas where some communications standards are not available.

Mobile telephone 100 includes a “talk” button 112 and an “end” button 114 for initiating and terminating calls, respectively. To dial another telephone, a user enters the telephone number for that telephone using numeric portion 110 of keypad 106 and presses “talk” button 112 to place the call. To “hang up” or terminate the call, the user presses “end” button 114.

In one possible embodiment, antenna 103 is retractable, and its extension and retraction is controlled by a motor. In this embodiment, “talk” button 112 and “end” button 114 may be used to control the extension and retraction of antenna 103. Specifically, antenna 103 is extended when the user presses “talk” button 112 to place a call and is retracted when the user presses “end” button 114 to end the call. In an alternative embodiment, antenna 103 may be retracted manually into the body of mobile telephone 100.

Mobile telephone 100 also includes a liquid-crystal (LCD) display 118 for indicating to a user the status of mobile telephone 100, including such information as the current signal strength, whether the user has received a voice or text message, and the current level of battery power. In some mobile telephones, display 118 may be used for executing software, such as games, or for browsing World Wide Web documents loaded from the Internet through a wireless connection using antenna 103. Arrow keys 116 may be used to navigate a user interface (for example, by manipulating a menu bar) in display 118.

A user of mobile telephone 100 will generally rely on a service provider to provide a wireless gateway into the PSTN. In addition to allowing a user to send and receive telephone calls, a service provider may provide additional features to customers. One of these features, as was already mentioned, is wireless Internet access. Another is voice mail. If the user of the mobile telephone 100 is unavailable (i.e., has turned off mobile telephone 100, is already talking to someone using mobile telephone 100, or simply ignores the ringing mobile telephone 100), a caller calling mobile telephone 100 can be switched into a voice mail service, where the caller can leave a message for the user of mobile telephone 100. An indicator, such as an envelope icon (e.g., envelope icon 117), can appear in display 118. The user of mobile telephone 100 can later access the voice mail service by pressing a special voice-mail button or by calling a special telephone number (such as *123, for instance). The user can then use keypad 106 to enter DTMF tones to select recited voice mail menu options.

In accordance with a preferred embodiment of the present invention, two light emitting diodes (LEDs) 120 and 122 are located beneath the translucent keycaps of “end” and “talk” buttons 114 and 112 and are employed to apprise the user of the status of an attempted telephone call. In a preferred embodiment, LED 120 is a red LED, while LED 122 is green, thus providing an intuitive semiotic suggestion of “stop” and “go.” After dialing a party (by entering a number on keypad 106 and pressing “talk” button 112), red LED 120 lights to show that a call attempt is being made. During this time, it is not necessary for the user to listen through earpiece 102 to see if the call has connected. The user need only watch LEDs 120 and 122. Once the called party has answered the call, green LED 122 lights to show that the call has been successfully connected and that the user should now put mobile telephone up to his or her ear and begin speaking.

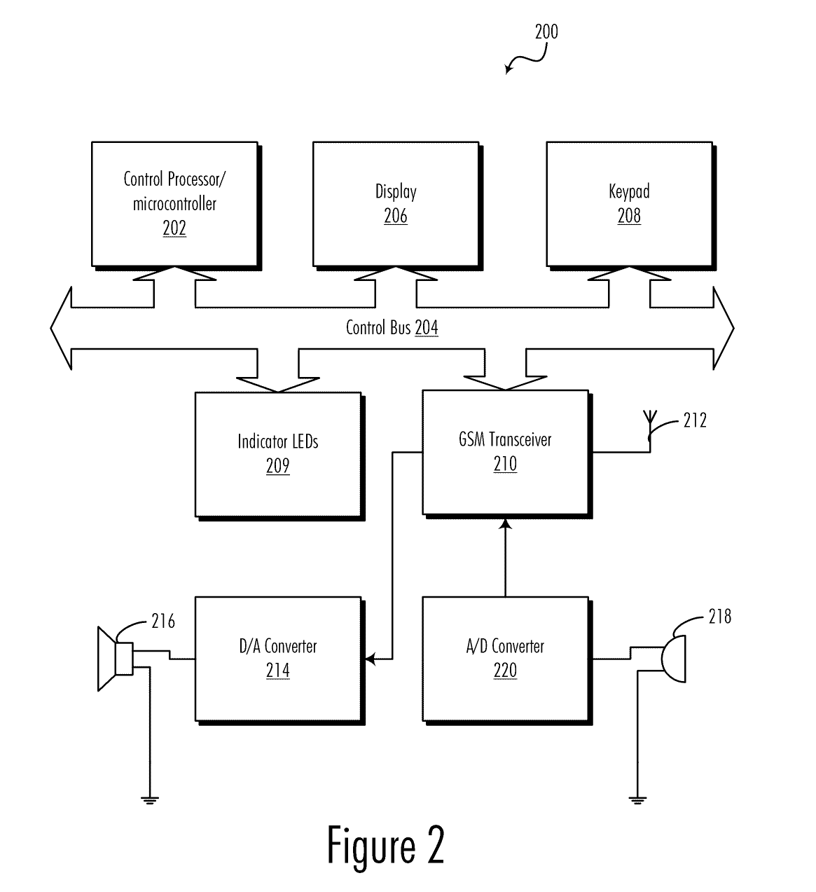

FIG. 2 is a block diagram illustrating an electronic hardware system 200 providing the computational and telecommunications platform for a preferred embodiment of the present invention. A control processor 202 provides a central point of control for the mobile telephone. Preferably, control processor 202 comprises some form of microcontroller, digital signal processor, or embedded processor core (such as an ARM 7 processor core, produced by ARM, Ltd. of Cambridge, England, for example), programmed with software for controlling the operation of the mobile telephone.

A control bus 204 connects control processor 202 to the other hardware components of system 200. Display 206 represents the hardware interface to LCD display 118 depicted in FIG. 1. Similarly, keypad 208 represents the hardware interface to keypad 106 in FIG. 1 and indicator LEDs 309 represents the hardware interface to LEDs 120 and 122 in FIG. 1.

Also connected to control bus 204 is GSM transceiver 210. GSM transceiver 210 is the portion of system 200 that handles the encoding, decoding, transmission, and reception of digital voice and data signals over the wireless telephone network, as well as the connection and termination of wireless telephone calls. In this preferred embodiment transceiver 210 encodes, decodes, transmits, and receives according to the international GSM (Global System for Mobile telecommunications) standard, although one skilled in the art will recognize that any of a number of different communications standards can be used in an embodiment of the present invention without departing from the scope and spirit of the present invention. An ultra high-frequency (UHF) or microwave antenna 212 is provided for transmission and reception of mobile telephone signals.

Digital audio signals received by GSM transceiver 210 are converted by digital-to-analog (D/A) converter 214 into a continuous analog signal that is output by speaker 216 (through earpiece 102 in FIG. 1). Analog audio input is received by microphone 218, converted into digital form by analog-to-digital (A/D) converter 220, and fed into GSM transceiver 210 for transmission over the wireless telephone network.

Returning now to control processor 202, control processor 202 coordinates and controls the operation of the other components in system 200. Control processor 202 takes user input from keypad 208, as well as digital audio data from A/D converter 220 and microphone 218 and directs the components of system 200 to perform the task(s) requested by the user. When the user dials a telephone number using keypad 208, this input is read by control processor 202 over control bus 204, and in response, control processor 202 directs GSM transceiver 210 to initiate a wireless telephone connection to the desired telephone number.

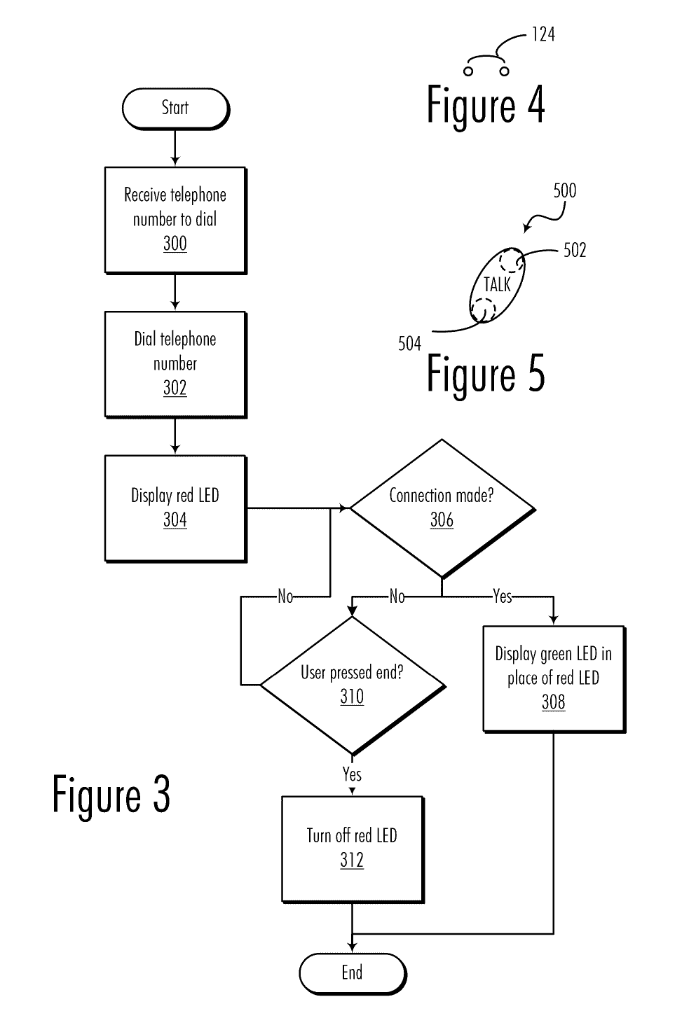

FIG. 3 is a flowchart representation of a process of visually notifying a user of a mobile telephone that a connection has or has not succeeded, in accordance with a preferred embodiment of the present invention. This process is intended to be executed by control processor 202 in FIG. 2 so as to control the operation of the mobile telephone. First, a telephone number to dial is received from the user, via keypad 208 (block 300). GSM transceiver 310 is used to dial the telephone number and await a connection (block 302). At this point, red LED 120 is lit to indicate that a connection attempt is in progress (block 304).

A determination is then made as to whether a connection has been successfully made (i.e., the called party has answered the call) (block 306). If so (block 306:Yes), then green LED 122 is lit in place of red LED 120 to indicate that the connection was successful.

If not (block 306:No), then a determination is made as to whether the user pressed “End” key 114 (block 310). If so (block 310:Yes), then the call attempt has been terminated and red LED 120 is extinguished (block 312), with the process terminating thereafter. If not (block 310:No), then the process cycles back to block 306 to await a connection.

One skilled in the art will recognize that a number of variations on the present invention may be made without departing from the scope and spirit of the same. For example, rather than using two LEDs, a single LED might be used, in which the LED blinks while an attempt is being made to connect, but shines continuously once the connection has been successfully made. Or, alternatively, two LEDs may be used where the green LED blinks while attempting to connect, then blinks more rapidly one the connection is made, and where, if the connection fails, a red LED lights.

Further, instead of using LEDs or other visual means of indicating that a connection has been made, other sensory means, such as sound, or vibration may be utilized in lieu of or in addition to the visual means described above. A repetitive sound that plays while a connection attempt is being made may increase in tempo when a connection succeeds, for example. This sound-based indicator may also be combined with a speakerphone function, to allow the user to determine who or what (in the case of an answering machine or voice mail) has picked up the phone on the other end. As another example, the telephone may vibrate weakly while trying to make a connection, then vibrate strongly once the connection has been made, or shake once or twice and stop if the connection fails.

As another variation on the preferred embodiment, the mobile telephone might produce one signal if the connection is made successfully and another signal if the connection fails. For example, the telephone might light a red LED in the event that the call fails and a green LED in the event that the call successfully connects. As shown in FIG. 5, these red and green LEDs 502 and 504 (respectively) may be incorporated together into a translucent talk button 500.

Another possible signaling method is represented by icon 124 in FIG. 1, which comprises two circles with a sequence of dots moving from one of the circles to the other while connection is being attempted. When the connection is made, the moving dots are replaced with a solid line, as in FIG. 4.

Alternatively, different sounds or ringtones may be played to the user to indicate whether or not the call was successful (e.g., ascending tone sequence to indicate successful call, descending tone sequence to indicate failure). Or, in another embodiment, the telephone may play a repeating melody or ostinato pattern while attempting to connect, then play a discernable ending sequence when the connection succeed or fails (such as an ascending or descending melodic line or other cadential figure). Synthesized musical tones may be used or digitally recorded music, such as a recording of one or more musical instruments, such as a brass ensemble, string ensemble, or orchestra, for example. Recorded human vocal or choral music may be used as well. In addition to recorded music, other forms or recorded sound may be utilized as well, such as recorded bird song, recorded animal calls, recorded insect noises, or other recorded sounds of nature. Also, any of a number of recorded or simulated artificial sounds, such as bells, sirens, car horns, etc. may be used.

One of the preferred implementations of the present invention includes a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A method operable in a mobile telephone, the method comprising:
attempting to place a telephone call over a wireless connection; and
in response to the telephone call's successfully connecting, providing a signal to a user of the mobile telephone to indicate that the telephone call has been successfully connected.

2. The method of claim 1, wherein the signal is a visual signal.

3. The method of claim 2, wherein the visual signal is a light that illuminates in the event that the telephone call has been successfully connected.

4. The method of claim 3, wherein the light is provided by a light emitting diode (LED).

5. The method of claim 1, further comprising:
in response to the telephone call's failing to connect, providing a different signal to indicate that the telephone call has failed to connect.

6. The method of claim 1, wherein the signal is an audible signal.

7. A computer program product in a computer readable medium, comprising functional descriptive material that, when executed by a computer, directs the computer to perform actions that include:
attempting to place a telephone call over a wireless connection; and
in response to the telephone call's successfully connecting, providing a signal to a user of the mobile telephone to indicate that the telephone call has been successfully connected.

8. The computer program product of claim 7, wherein the signal is a visual signal.

9. The computer program product of claim 8, wherein the visual signal is a light that illuminates in the event that the telephone call has been successfully connected.

10. The computer program product of claim 10, wherein the light is provided by a light emitting diode (LED).

11. The computer program product of claim 9, comprising additional functional descriptive material that, when executed by the computer, directs the computer to perform actions that include:
in response to the telephone call's failing to connect, providing a different signal to indicate that the telephone call has failed to connect.

12. The computer program product of claim 9, wherein the signal is an audible signal.

13. The computer program product of claim 12, wherein the audible signal includes recorded sounds.

14. The computer program product of claim 13, wherein the recorded sounds include recorded music.

15. The computer program product of claim 12, wherein the audible signal includes animal sounds, bird sounds, or nature sounds.

16. A telecommunications device comprising:
call attempting means for attempting to place a telephone call over a wireless connection; and
signaling means, responsive to the telephone call's successfully connecting, for providing a signal to a user of the mobile telephone to indicate that the telephone call has been successfully connected.

17. The telecommunications device of claim 16, wherein the signaling means provides a visual signal.

18. The telecommunications device of claim 17, wherein the signaling means includes a light that illuminates in the event that the telephone call has been successfully connected.

19. The telecommunications device of claim 17, further comprising:
at least one extendable section, wherein the at least one extendable section includes either an earpiece or a microphone, and wherein the extendable section may be extended in an outward direction from the mobile telephone so as to elongate the mobile telephone.

20. The telecommunications device of claim 17, further comprising:
second signaling means, responsive to the telephone call's failing to connect, for providing a different signal to indicate that the telephone call has failed to connect.

21. The telecommunications device of claim 17, further comprising:
a first end and a second end;
an earpiece associated with the first end;
a microphone associated with the second end; and
an antenna extending in an outward direction from the second end.

22. The telecommunications device of claim 21, wherein the antenna is retractable.

23. The telecommunications device of claim 22, wherein the antenna is automatically extended when the telephone call is placed and automatically retracted when the telephone call ends.

24. The telecommunications device of claim 16, wherein the telecommunications device is a handheld unit of a cordless telephone.

25. The telecommunications device of claim 16, wherein the telecommunications device is a 2-way radio transceiver.
